(19) United States
(12) Patent Application Publication
(10) Pub. No.: US 2005/0271979 A1
(43) Pub. Date: Dec. 8, 2005

(54) Photosensitive paste composition, PDP electrode prepared therefrom, and PDP comprising the PDP electrode

(76) Inventors: Beom-Wook Lee, Suwon-si (KR); Dong-Hee Han, Suwon-si (KR); Sang-Wook Sin, Suwon-si (KR); Jin-Hwan Jeon, Suwon-si (KR)

Correspondence Address: Robert E. Bushnell, Suite 300, 1522 K Street, N.W., Washington, DC, 20005, US

(21) Appl. No.: 11/143,712

(22) Filed: Jun. 3, 2005

(30) Foreign Application Priority Data
Jun. 7, 2004 (KR) 10-2004-0041322

(51) Int. Cl. G03C 1/492

(52) U.S. Cl. 430/270.1

(57) ABSTRACT

A photosensitive paste composition including a conductive particle, an inorganic binder, and an organic vehicle, in which the amount of solids in the organic vehicle is 8 to 12 parts by weight based on 100 parts by weight of the composition and 10 to 20 parts by weight based on 100 parts by weight of the conductive particle. When using the photosensitive paste composition, the thickness shrinkage rate of a dried film upon burning is reduced to less than 40%, and thus an edge-curl phenomenon that an edge portion of an electrode pattern is curled is minimized. Thus, a PDP electrode having an increased withstand voltage and a PDP including the PDP electrode can be provided.

### CLAIM OF PRIORITY

This application claims the benefit of Korean Patent Application No. 10-2004-0041322, filed on Jun. 7, 2004, in the Korean Intellectual Property Office, the disclosure of which is incorporated herein in its entirety by reference.

### BACKGROUND OF THE INVENTION

1. Field of the Invention

The present invention relates to a photosensitive paste composition, a plasma display panel (PDP) electrode prepared therefrom, and a PDP comprising the PDP electrode.

2. Description of the Related Art

Recently, as the need for large, high density, high precision and highly reliable display devices increases, a variety of patterning technologies are being developed. Also, a variety of compositions for forming a microelectrode suitable for the variety of patterning technologies are actively being developed.

A plasma display panel (hereinafter, referred to as “PDP”) is currently used in various fields since it has a fast response speed and can be easily made large compared to a liquid crystal panel. Conventionally, electrodes are generally formed on the PDP by patterning an electrode material using a screen printing method. However, since the screen printing method requires great skill and precision by screen is poor, it is difficult to obtain a high precision and large screen pattern required for the PDP using the screen printing method. When using the screen printing method, it is difficult to form a micropattern due to a short circuit by screen upon printing and the limited resolution.

Thus, to form a high precision electrode circuit suitable for large area, photolithography using a photosensitive conducting paste was developed. The photolithography is a method of forming a patterned electrode by printing the photosensitive conducting paste on a front side of a glass substrate, etc., performing a predetermined drying process, exposing the resultant using a UV exposing apparatus equipped with a photomask, developing and removing an uncured portion, which is blocked by the photomask, with a certain developing solution, and burning the remained cured film at a predetermined temperature.

However, since in the burning process, a width shrinkage rate is 15 to 30% and a thickness shrinkage rate is 50 to 70%, an edge-curl phenomenon in which an edge portion of the pattern is curled is caused by a difference between the width shrinkage rate and the thickness shrinkage rate (see FIG. 1).

The edge-curl phenomenon deteriorates the withstand voltage property, thereby decreasing the lifespan and the luminous efficiency of a PDP product, and electrodes of a terminal are damaged during a sanding process so that the PDP display is not driven. It has been discussed that the edge-curl phenomenon is caused by an under-cut phenomenon that a pattern has an inverted trapezoidal shape after the developing process. However, as a result of repeated studies, the inventors of the present invention discovered that though an occurrence of the under-cut phenomenon is prevented by improving an exposure sensitivity and conditions for the development, the edge-curl phenomenon occurs. Also, the inventors discovered that, to minimize the edge-curl phenomenon, the thickness shrinkage rate which is relatively great compared to the width shrinkage rate upon burning must be minimized.

### SUMMARY OF THE INVENTION

It is therefore an object of the present invention to provide a photosensitive paste composition.

It is also an object of the present invention to provide an improved plasma display panel (PDP) electrode.

It is another object of the present invention to provide an improved plasma display panel (PDP).

The present invention provides a photosensitive paste composition which can minimize a thickness shrinkage rate and thus minimize an edge-curl phenomenon, thereby improving a withstand voltage property and resistance to sanding and ultimately increasing the lifespan, the luminous efficiency and the yield of a PDP product, a PDP electrode prepared using the photosensitive paste composition, and a PDP including the PDP electrode.

According to an aspect of the present invention, there is provided a photosensitive paste composition including a conductive particle, an inorganic binder and an organic vehicle, in which the amount of solids in the organic vehicle is 8 to 12 parts by weight based on 100 parts by weight of the composition and is 10 to 20 parts by weight based on 100 parts by weight of the conductive particle.

According to another aspect of the present invention, there is provided a PDP electrode prepared using the photosensitive paste composition.

According to another aspect of the present invention, there is provided a PDP including the PDP electrode.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a photograph of a cross-section of a curled edge of a pattern after burning; and

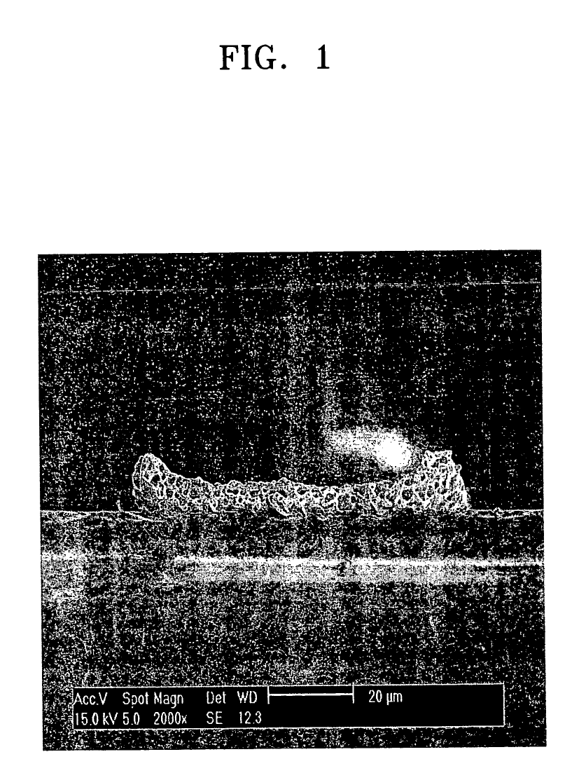

FIG. 2 is a partially exploded perspective view of a PDP including a PDP electrode prepared according to an embodiment of the present invention.

### DETAILED DESCRIPTION OF THE INVENTION

A photosensitive paste composition of an embodiment of the present invention includes a conductive particle (preferably powder), an inorganic binder, and an organic vehicle, in which the amount of solids in the organic vehicle is 8 to 12 parts by weight based on 100 parts by weight of the composition and 10 to 20 parts by weight based on 100 parts by weight of the conductive particle.

The important thing in the method of minimizing the shrinkage rate in a burning process is minimizing the amount of organic components removed by being fired. Although the conductive particles are also shrunk by being sintered upon burning and the shrinkage rate is varied according to the size and the shape of conductive particles, the conductive particles negligibly influence the shrinkage rate, compared to the removal of organic components. Also, although the inorganic binder influences the shrinkage rate, the effect thereof on the overall shrinkage rate is negligible because its shrinkage rate is low and its amount is very small.

To minimize the amount of solids (organic materials except for a solvent) among the vehicle components, the required minimum amounts of the respective organic components are investigated. As a result, the required amounts vary according to properties and amounts of the conductive particles and the inorganic binder, in particular, the kind of organic solid component (a binder, a photoinitiator, a crosslinking agent, etc.). The photosensitive paste compositions with a variety of compositional ratios are evaluated. As a result, it is discovered that to minimize the edge-curl phenomenon upon burning, the thickness of a dried film should be minimized by primarily minimizing the amount of solids in the organic vehicle.

Thus, in the present invention, the amount of solids in the organic vehicle is adjusted to be 8 to 12 parts by weight based on 100 parts by weight of the composition and to be 10 to 20 parts by weight based on 100 parts by weight of the conductive particle, thereby minimizing the amount of the organic component fired and removed upon burning, and thus minimizing the shrinkage rate in the burning process. When the amount of solids is less than 8 parts by weight based on 100 parts by weight of the composition or less than 10 parts by weight based on 100 parts by weight of the conductive particle, a viscosity of the photosensitive paste is too low to print, or an exposure sensitivity is poor, and thus a desired linewidth cannot be obtained. When the amount of solids is greater than 12 parts by weight based on 100 parts by weight of the composition or greater than 20 parts by weight based on 100 parts by weight of the conductive particle, a dried film is thick, and thus the shrinkage rate upon burning exceeds 40%, resulting in edge-curl.

Ag, Au, Cu, Pt, Pd, Al or an alloy thereof may be used as the conductive particle. The Ag powder is preferred. The conductive particle has preferably a spherical shape because spherical particles have better filling ratio and UV permeability than plate-shaped or amorphous particles.

The conductive particles have a specific surface area ranging from 0.3 to 2 m²/g and an average particle diameter ranging from 0.1 to 5 μm. When the specific surface area is less than 0.3 m²/g or the average particle diameter is greater than 5 μm, a rectilinear path of a burned film pattern is poor and the resistance of the burned film increases. When the specific surface area is greater than 2 m²/g or the average particle diameter is less than 0.1 μm, dispersion and exposure sensitivity of the paste are poor.

The photosensitive paste composition of the present embodiment preferably includes 0.1 to 10 parts by weight of the inorganic binder and 20 to 100 parts by weight of the organic vehicle, based on 100 parts by weight of the conductive particle.

When the amount of the conductive particle is less than 100 parts by weight, the linewidth of the conductive film is seriously shrunk and short circuit may occur. When the amount of the conductive particle is greater than 100 parts by weight, a desired pattern cannot be obtained due to poor printability and an insufficient crosslinking reaction by low light permeability.

The inorganic binder in the photosensitive paste composition improves a sintering property of the conductive particle and allows the conductive particle to adhere to a glass substrate. The amount of the inorganic binder is preferably 0.1 to 10 parts by weight based on 100 parts by weight of the conductive particle. When the amount of the inorganic binder is less than 0.1 part by weight, the conductive particle is not easily sintered and the adhesion of the conductive film to the glass substrate is reduced, thereby causing the conductive film to be released. When the amount of the inorganic binder is greater than 10 parts by weight, the resistance of the conductive film increases.

A Pb-containing inorganic binders or a Pb-free inorganic binder may be used as the inorganic binder. Examples of such an inorganic binder include, but are not limited to, composite oxides of Pb or Bi, Si, B, Ba, Zn, Mg, Ca and Li. Specifically, PbO—SiO₂-based Pb-containing inorganic binders, PbO—SiO₂—B₂O₃-based Pb-containing inorganic binders, PbO—SiO₂—B₂O₃—BaO-based Pb-containing inorganic binders, or PbO—SiO₂—B₂O₃—BaO—ZnO-based Pb-containing inorganic binders, or Bi₂O₃—SiO₂—B₂O₃-based Pb-free inorganic binders, Bi₂O₃—SiO₂—B₂O₃—BaO-based Pb-free inorganic binders, Bi₂O₃—SiO₂—B₂O₃—BaO—ZnO-based Pb-free inorganic binders, ZnO—SiO₂—B₂O₃—BaO-based Pb-free inorganic binders, MgO—CaO—SiO₂—B₂O₃—BaO-based Pb-free inorganic binders, Li₂O—MgO—SiO₂—B₂O₃—BaO-based Pb-free inorganic binders or P₂O₅-based Pb-free inorganic binders may be used alone or in a mixture of two or more.

The appearance of the inorganic binder particle is not particularly restricted, but may be spherical and an average particle diameter thereof is preferably 5 μm or less. When the average particle diameter is greater than 5 μm, the burned film is uneven and the rectilinear path of the burned film pattern is poor.

The inorganic binder has a softening temperature ranging from 400 to 600° C. When the softening temperature is lower than 400° C., the organic materials are not easily decomposed upon burning. When the softening temperature is higher than 600° C., the inorganic binder cannot be softened since the glass substrate is bent at a temperature higher than 600° C., and thus the burning temperature is preferably not higher than 600° C.

The amount of the organic vehicle in the photosensitive paste composition is 20 to 100 parts by weight based on 100 parts by weight of the conductive particle. When the amount of the organic vehicle is less than 20 parts by weight, the printability of the paste is poor and the exposure sensitivity is reduced. When the amount of the organic vehicle is greater than 100 parts by weight, the amount of the conductive particle is relatively small, and thus the linewidth of the conductive film is seriously shrunk and short circuit occurs.

The organic vehicle includes a copolymer of a monomer having a carboxylic group and at least one ethylenically unsaturated monomer, a crosslinking agent, a photoinitiator, and a solvent. The solvent is preferably texanol, and it is preferred that the organic vehicle includes cellulose.

The organic vehicle includes 20 to 150 parts by weight of the crosslinking agent, 10 to 150 parts by weight of the photoinitiator, and 100 to 500 parts by weight of the solvent with respect to 100 parts by weight of the copolymer of the monomer having a carboxylic group and at least one ethylenically unsaturated monomer.

The copolymer of the monomer having a carboxylic group and at least one ethylenically unsaturated monomer allows the composition of the present invention to be developed by an alkaline aqueous solution. When the amount of the copolymer in the organic vehicle is less than 100 parts by weight, the printability is poor. When the amount of the copolymer is greater than 100 parts by weight, the developing ability is poor and residues can be generated around the burned film.

The monomer having a carboxylic group is preferably at least one selected from the group consisting of acrylic acid, methacrylic acid, fumaric acid, maleic acid, vinyl acetic acid, and anhydrides thereof. The ethylenically unsaturated monomer is preferably at least one selected from the group consisting of methylacrylate, methylmethacrylate, ethylacrylate, ethylmethacrylate, n-butylacrylate, n-butylmethacrylate, isobutylacrylate, isobutylmethacrylate, 2-hydroxyethylacrylate, 2-hydroxyethylmethacrylate, ethyleneglycolmonomethyletheracrylate, and ethyleneglycolmonomethylethermethacrylate.

The binder may include a crosslinkable group formed by reacting the carboxylic group of the copolymer with an ethylenically unsaturated compound. The ethylenically unsaturated compound may be selected from the group consisting of glycidylmethacrylate, 3,4-epoxycyclohexylmethylmethacrylate, and 3,4-epoxycyclohexylmethylacrylate.

The copolymer can be used alone, or can be used in combination with at least one material selected from the group consisting of cellulose, hydroxymethylcellulose, hydroxyethylcellulose, carboxymethylcellulose, carboxyethylcellulose, and carboxyethylmethylcellulose to improve film leveling or thixotropy.

The copolymer has a molecular weight of 5,000 to 50,000 g/mol and an acid value of 20 to 100 mgKOH/g. When the molecular weight of the copolymer is less than 5,000 g/mol, the printability of the paste is poor. When the molecular weight of the copolymer is greater than 50,000 g/mol, a non-exposed portion is not removed upon development. When the acid value of the copolymer is less than 20 mgKOH/g, the developing ability is poor. When the acid value of the copolymer is greater than 100 mgKOH/g, even the exposed portion is developed.

Monofunctional and multifunctional monomers may be used as the crosslinking agent. Multifunctional monomers with good exposure sensitivity are generally used. Examples of such multifunctional monomers include, but are not limited to, diacrylates such as ethyleneglycoldiacrylate (EGDA); triacrylates such as trimethylolpropanetriacrylate (TMPTA), trimethylolpropaneethoxylatetriacrylate (TMPEOTA), or pentaerythritoltriacrylate; tetraacrylates such as tetramethylolpropanetetraacrylate or pentaerythritoltetraacrylate; and hexaacrylates such as dipentaerythritolhexaacrylate (DPHA). The amount of the crosslinking agent is 20 to 150 parts by weight based on 100 parts by weight of the copolymer binder. When the amount of the crosslinking agent is less than 20 parts by weight, the exposure sensitivity is poor, and thus a desired linewidth of the burned film cannot be obtained. When the amount of the crosslinking agent is greater than 150 parts by weight, residues are generated on the burned film.

Examples of the photoinitiator include, are not limited to, benzophenone, methyl o-benzoylbenzoate, 4,4-bis(dimethylamine)benzophenone, 4,4-bis(diethylamino)benzophenone, 2,2-diethoxyacetophenone, 2,2-dimethoxy-2-phenyl-2-phenylacetophenone, 2-methyl-[4-(methylthio)phenyl]-2-morpholinopropane-1-one, 2-benzyl-2-dimethylamino-1-(4-morpholinophenyl)-1-butanone, bis(2,6-dimethoxybenzoyl)-2,4,4-trimethylpentylphosphineoxide, and bis(2,4,6-trimethylbenzoyl)phenylphosphineoxide. The amount of the photoinitiator is 5 to 150 parts by weight based on 100 parts by weight of the copolymer binder. When the amount of the photoinitiator is less than 5 parts by weight, the exposure sensitivity of the paste is poor, and thus a desired linewidth of the burned film cannot be obtained. When the amount of the photoinitiator is greater than 150 parts by weight, the linewidth of the burned film is large or residues are generated around the burned film.

The solvent may be one that can dissolve the binder and the photoinitiator, that can be compatible with the crosslinking agent and other additives, and that has a boiling point of 150° C. or higher. When the boiling point is lower than 150° C., the solvent is easily volatilized during preparing the composition, in particular, a 3-roll mill process, and a printing state is poor due to rapid volatilization of the solvent. Examples of the solvent satisfying the above requirements include, are not limited to, ethylcarbitol, butylcarbitol, ethylcarbitolacetate, butylcarbitolacetate, texanol, terpine oil, dipropyleneglycolmethylether, dipropyleneglycolethylether, dipropyleneglycolmonomethyletheracetate, γ-butyrolactone, cellosolveacetate, butylcellosolveacetate, and tripropyleneglycol. The amount of the solvent is preferably 100 to 500 parts by weight based on 100 parts by weight of the copolymer binder. When the amount of the solvent is less than 100 parts by weight, the viscosity of the paste is too high, and thus the printing process is not easily performed. When the amount of the solvent is greater than 500 parts by weight, the viscosity of the paste is too low, and thus the printing process cannot be performed.

The organic vehicle may further include a sensitizer for improving sensitivity, a polymerisation inhibitor and an antioxidant for stably storing the composition, a UV absorbent for improving resolution, an antifoaming agent for reducing foams in the composition, a dispersant for improving dispersion, a leveling agent for improving evenness of the film upon printing, and a plasticizer for providing thixotropy, etc.

In another embodiment of the present invention, there is provided a PDP electrode prepared using the photosensitive paste composition described above. The PDP electrode is prepared through a forming process of a micropattern and a burning process.

The forming process of a micropattern includes: printing the photosensitive paste composition prepared as described above on a substrate using a screen printer using a screen mask, such as SUS 325 mesh or SUS 400 mesh; drying the coated specimen in a convection oven or IR oven at 80 to 150° C. for 5 to 30 minutes; exposing the formed paste coating to a proper light source at 300 to 450 nm to form a micropattern; and developing the micropattern with a proper alkaline developing solution, such as a Na₂CO₃ solution, KOH, TMAH, etc., at about 30° C. The burning process includes burning the formed micropattern in an electric furnace at 500 to 600° C. for 10 to 30 minutes.

In another embodiment of the present invention, there is provided a PDP including a PDP electrode prepared as described above.

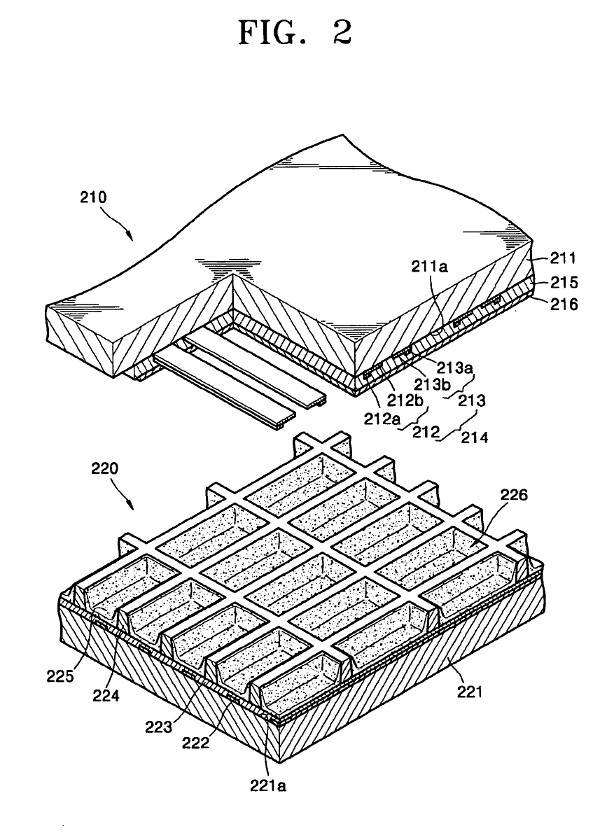

FIG. 2 illustrates a structure of a PDP including a PDP electrode according to an embodiment of the present invention. The PDP electrode prepared using the composition according to the present invention can be used for the preparation of white electrodes and address electrodes of bus electrodes.

The PDP prepared according to the present invention includes a front panel 210 and a rear panel 220. The front panel 210 includes a front substrate 211, sustain electrode pairs 214 having Y electrodes 212 and X electrodes 213 formed on a rear surface 211a of the front substrate, a front dielectric layer 215 covering the sustain electrode pairs 214, and a protecting layer 216 covering the front dielectric layer. Each of Y electrodes 212 and X electrodes 213 has transparent electrodes 212b and 213b preferably composed of ITO etc.; and bus electrodes 212a and 213a preferably including a black electrode (not shown) for improving darkness and a white electrode (not shown) for providing conductivity. Thus, bus electrodes 212a and 213a are connected to connection cables disposed at left and right sides of the PDP.

The rear panel 220 includes a rear substrate 221, address electrodes 222 formed on a front surface 221a of the rear substrate so as to cross the sustain electrode pairs 214, a rear dielectric layer 223 covering the address electrodes, a spacer 224 formed on the rear dielectric layer to divide light emitting cells 226, and a fluorescent layer 225 disposed in the light emitting cell 226. The address electrodes 222 are connected to connection cables disposed at upper and lower sides of the PDP.

The present invention will now be described in greater detail with reference to the following examples. The following examples are for illustrative purposes only and are not intended to limit the scope of the invention.

### EXAMPLES

### Example 1

### Preparation of Photosensitive Paste Composition

60.0% by weight of an Ag powder (spherical, specific surface area 0.78 m²/g, average particle diameter=1.12 μm), 3.0% by weight of an inorganic binder (Dₘₐₓ=3.6 μm, amorphous, PbO—SiO₂—B₂O₃-based), 6.0% by weight of a copolymer binder (polyBMA-co-HEMA-co-MM, molecular weight 25,000 g/mol, acid value 64 mgKOH/g), 0.5% by weight of a photoinitiator (2-benzyl-2-diethylamino-1-(4-morpholinophenyl)-1-butanone), 3.0% by weight of a crosslinking agent (dipentaerythritolhexaacrylate), 27.3% by weight of a solvent (texanol), and 0.2% by weight of another additive (ether phosphate-based compound) were combined and stirred in a stirrer, and then kneaded using a 3-roll mill to prepare a photosensitive paste composition. At this time, the amount of solids in the organic vehicle was 9.7% by weight with respect to the photosensitive paste composition and 16.2 parts by weight based on 100 parts by weight of the Ag powder. In the preparation of the composition, the copolymer binder, the photoinitiator, the crosslinking agent, and the solvent were first combined to prepare the organic vehicle, and then glass frit and the Ag powder were added thereto.

### Example 2

### Preparation of Photosensitive Paste Composition

A photosensitive paste composition was prepared in the same manner as in Example 1, except that 65.0% by weight of an Ag powder, 3.0% by weight of an inorganic binder, 5.5% by weight of a copolymer binder, 0.6% by weight of a photoinitiator, 3.0% by weight of a crosslinking agent, 22.7% by weight of a solvent, and 0.2% by weight of another additive were combined. At this time, the amount of solids in the organic vehicle was 9.3% by weight with respect to the photosensitive paste composition and 14.3 parts by weight based on 100 parts by weight of the Ag powder.

### Example 3

### Preparation of Photosensitive Paste Composition

A photosensitive paste composition was prepared in the same manner as in Example 1, except that 70.0% by weight of an Ag powder, 3.0% by weight of an inorganic binder, 5.0% by weight of a copolymer binder, 0.7% by weight of a photoinitiator, 3.0% by weight of a crosslinking agent, 18.1% by weight of a solvent, and 0.2% by weight of another additive were combined. At this time, the amount of solids in the organic vehicle was 8.9% by weight with respect to the photosensitive 19 paste composition and 12.7 parts by weight based on 100 parts by weight of the Ag powder.

### Comparative Example

### Preparation of Photosensitive Paste Composition

A photosensitive paste composition according to a conventional technology was prepared in the same manner as in Example 1, except that 65.0% by weight of an Ag powder, 3.0% by weight of an inorganic binder, 8.0% by weight of a copolymer binder, 0.6% by weight of a photoinitiator, 5.0% by weight of a crosslinking agent, 18.2% by weight of a solvent, and 0.2% by weight of another additive were combined. At this time, the amount of solids in the organic vehicle was 13.8% by weight with respect to the photosensitive paste composition and 21.2 parts by weight based on 100 parts by weight of the Ag powder.

The amounts of the respective components in compositions of Examples 1, 2, and 3 and Comparative Example are indicated in Table 1.

TABLE 1

| | | | | Comparative |
|---|---|---|---|---|
| Component | Example 1 | Example 2 | Example 3 | Example |
| Conductive | 60.0 | 65.0 | 70.0 | 65.0 |
| particles | | | | |
| Inorganic | 3.0 | 3.0 | 3.0 | 3.0 |
| binder | | | | |
| Copolymer | 6.0 | 5.5 | 5.0 | 8.0 |
| binder | | | | |
| Photoinitiator | 0.5 | 0.6 | 0.7 | 0.6 |
| Crosslinking | 3.0 | 3.0 | 3.0 | 5.0 |
| agent | | | | |
| Other additive | 0.2 | 0.2 | 0.2 | 0.2 |
| Solvent | 27.3 | 22.7 | 18.1 | 18.2 |
| Solids in | 9.7 | 9.3 | 8.9 | 13.8 |
| organic vehicle | | | | |
| (parts by | | | | |
| weight) | | | | |
| Solids with | 16.2 | 14.3 | 12.7 | 21.2 |
| respect to | | | | |
| conductive | | | | |
| particle (parts | | | | |
| by weight) | | | | |

(unit: % by weight)

Performance Test

PDP electrodes were prepared using compositions of Examples 1, 2, and 3, and Comparative Example under the following processing conditions and their characteristics were evaluated.
i) Printing was performed on a 20 cm×20 cm glass substrate using a screen printing method.
ii) Drying was performed in a dry oven at 100° C. for 15 minutes.
iii) The thickness of dried film was measured using film thickness measuring equipment.
iv) UV light of 500 mJ/cm² was radiated using a UV exposing device equipped with a high pressure mercury lamp.
v) Developing was performed by spraying a 0.4% aqueous NaCO₃ solution at a nozzle pressure of 1.5 kgf/cm².
vi) Burning was performed using an electric furnace at 550° C. for 15 minutes.
vii) The thickness of the burned film was measured using film thickness measuring equipment.
viii) Edge-curl was evaluated by observing the cross section of the burned film using three-dimensional measuring equipment and a scanning electron microscope (SEM).
ix) A dielectric substance was printed, dried and burned on the burned film to form a dielectric film.
x) Withstand voltage was measured using a withstand voltage meter.

The results are indicated in Table 2.

TABLE 2

| | | | | Comparative |
|---|---|---|---|---|
| Characteristic | Example 1 | Example 2 | Example 3 | Example |
| Thickness (μm) | 5.5 | 5.7 | 6.0 | 8.5 |
| of dried film | | | | |
| Thickness (μm) | 3.5 | 3.7 | 4.0 | 3.5 |
| of burned film | | | | |
| Burning | 36.4 | 35.1 | 33.3 | 58.8 |
| shrinkage rate | | | | |
| (%) | | | | |
| Height (μm) of | 4.2 | 2.2 | 2.9 | 7.2 |
| edge | | | | |
| Edge curl (%) | 20.0 | 18.9 | 22.5 | 105.7 |
| Withstand | 720 | 730 | 690 | 520 |
| voltage (V) | | | | |

Burning shrinkage rate (%): ((Thickness of dried film − Thickness of burned film)/Thickness of dried film) × 100
Edge-curl (%): ((Height of edge − Thickness of burned film)/Thickness of burned film) × 100

As can be seen from the results of table 2, when using compositions of Examples 1-3 in which the amount of solids in the organic vehicle is 12% by weight or less with respect to the paste composition and 10 to 20 parts by weight based on 100 parts by weight of the conductive particle, the burning shrinkage rate of each film is less than 40%, and thus, the edge-curl percentage is low and the withstand voltage is high. Meanwhile, when using the composition of Comparative Example having the amount of solids of the organic vehicle greater than 12% by weight, the burning shrinkage rate is 58.8%, and thus the edge-curl percentage is high and the withstand voltage is low.

According to the present invention, a photosensitive paste composition that can minimize a thickness shrinkage rate and minimize an edge-curl phenomenon, thereby improving a withstand voltage property and a resistance to sanding, and ultimately the lifespan, the luminous efficiency and the yield of a PDP product, a PDP electrode prepared using the photosensitive paste composition, and a PDP including the PDP electrode can be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A photosensitive paste composition, comprising:
a conductive particle;
an inorganic binder; and
an organic vehicle, the amount of solids in the organic vehicle being 8 to 12 parts by weight based on 100 parts by weight of the photosensitive paste composition and 10 to 20 parts by weight based on 100 parts by weight of the conductive particle.

2. The photosensitive paste composition of claim 1, wherein the conductive particle is spherical and has a specific surface area of 0.3 to 2 m²/g and an average particle diameter of 0.1 to 5 μm.

3. The photosensitive paste composition of claim 1, wherein the conductive particle is Ag powder.

4. The photosensitive paste composition of claim 1, wherein the organic vehicle comprises texanol and cellulose.

5. The photosensitive paste composition of claim 1, wherein the inorganic binder is a Pb-containing inorganic binder, a Pb-free inorganic binder or a mixture thereof and has a softening temperature of 400 to 600° C. and an average particle diameter of 5 μm or less.

6. The photosensitive paste composition of claim 5, wherein the Pb-containing inorganic binder is PbO—SiO₂-based, PbO—SiO₂—B₂O₃-based, PbO—SiO₂—B₂O₃—BaO-based, or PbO—SiO₂—B₂O₃—BaO—ZnO-based Pb-containing inorganic binder, and the Pb-free inorganic binder is Bi₂O₃—SiO₂—B₂O₃-based, Bi₂O₃—SiO₂—B₂O₃—BaO-based, Bi₂O₃—SiO₂—B₂O₃—BaO—ZnO-based, ZnO—SiO₂—B₂O₃—BaO-based, MgO—CaO—SiO₂—B₂O₃—BaO-based, Li₂O—MgO—SiO₂—B₂O₃—BaO-based or P₂O₅-based Pb-free inorganic binder.

7. The photosensitive paste composition of claim 1, wherein an amount of the inorganic binder is 0.1 to 10 parts by weight with respect to 100 parts by weight of the conductive particle, and an amount of the organic vehicle is 20 to 100 parts by weight with respect to 100 parts by weight of the conductive particle.

8. The photosensitive paste composition of claim 1, wherein the organic vehicle comprises a copolymer of a monomer having a carboxylic group and at least one ethylenically unsaturated monomer, a crosslinking agent, a photoinitiator, and a solvent.

9. The photosensitive paste composition of claim 8, wherein the organic vehicle comprises 20 to 150 parts by weight of the crosslinking agent, 10 to 150 parts by weight of the photoinitiator, and 100 to 500 parts by weight of the solvent with respect to 100 parts by weight of the copolymer of the monomer.

10. The photosensitive paste composition of claim 9, wherein the copolymer is in combination with at least one material selected from the group consisting of cellulose, hydroxymethylcellulose, hydroxyethylcellulose, carboxymethylcellulose, carboxyethylcellulose, and carboxyethylmethylcellulose.

11. The photosensitive paste composition of claim 9, wherein the monomer having a carboxylic group is at least one selected from the group consisting of acrylic acid, methacrylic acid, fumaric acid, maleic acid, vinyl acetic acid, and anhydrides thereof;
the ethylenically unsaturated monomer is at least one selected from the group consisting of methylacrylate, methylmethacrylate, ethylacrylate, ethylmethacrylate, n-butylacrylate, n-butylmethacrylate, isobutylacrylate, isobutylmethacrylate, 2-hydroxyethylacrylate, 2-hydroxyethylmethacrylate, ethyleneglycolmonomethyletheracrylate, and ethyleneglycolmonomethylethermethacrylate;
the crosslinking agent is at least one selected from the group consisting of diacrylates, triacrylates, tetraacrylates, and hexaacrylates;
the photoinitiator is at least one selected from the group consisting of benzophenone, methyl o-benzoylbenzoate, 4,4-bis(dimethylamine)benzophenone, 4,4-bis(diethylamino)benzophenone, 2,2-diethoxyacetophenone, 2,2-dimethoxy-2-phenyl-2-phenylacetophenone, 2-methyl-[4-(methylthio)phenyl]-2-morpholinopropane-1-one, 2-benzyl-2-dimethylamino-1-(4-morpholinophenyl)-1-butanone, bis(2,6-dimethoxybenzoyl)-2,4,4-trimethylpentylphosphineoxide, and bis(2,4,6-trimethylbenzoyl)phenylphosphineoxide; and
the solvent is at least one selected from the group consisting of ethylcarbitol, butylcarbitol, ethylcarbitolacetate, butylcarbitolacetate, texanol, terpine oil, dipropyleneglycolmethylether, dipropyleneglycolethylether, dipropyleneglycolmonomethyletheracetate, γ-butyrolactone, cellosolveacetate, butylcellosolveacetate, and tripropyleneglycol.

12. The photosensitive paste composition of claim 9, wherein the copolymer has a crosslinkable group formed by reacting the carboxylic group of the copolymer and an ethylenically unsaturated compound selected from the group consisting of glycidylmethacrylate, 3,4-epoxycyclohexylmethylmethacrylate, and 3,4-epoxycyclohexylmethylacrylate.

13. The photosensitive paste composition of claim 9, wherein the copolymer has a molecular weight of 5,000 to 50,000 g/mol and an acid value of 20 to 100 mgKOH/g.

14. The photosensitive paste composition of claim 9, wherein the solvent has a boiling point of at least 150° C.

15. The photosensitive paste composition of claim 9, wherein the organic vehicle further comprises at least one additive selected from the group consisting of a sensitizer, a polymerisation inhibitor, an antioxidant, a UV absorbent, an antifoaming agent, a dispersant, a leveling agent, and a plasticizer.

16. A plasma display panel electrode prepared using the photosensitive paste composition of claim 1.

17. A plasma display panel comprising the plasma display panel electrode of claim 16.

18. A photosensitive paste composition, comprising:
a conductive particle having a specific surface area of 0.3 to 2 m²/g and an average particle diameter of 0.1 to 5 μm;
an inorganic binder having a softening temperature of 400 to 600° C. and an average particle diameter of 5 μm or less, an amount of the inorganic binder being 0.1 to 10 parts by weight with respect to 100 parts by weight of the conductive particle; and
an organic vehicle, an amount of the organic vehicle being 20 to 100 parts by weight with respect to 100 parts by weight of the conductive particle, an amount of solids in the organic vehicle being 8 to 12 parts by weight based on 100 parts by 11 weight of the photosensitive paste composition and 10 to 20 parts by weight based on 100 parts by weight of the conductive particle.

19. A plasma display panel electrode prepared by a method comprising the steps of:
printing a photosensitive paste composition on a substrate to form a photosensitive paste film, the photosensitive paste composition comprising a conductive particle, an inorganic binder, and an organic vehicle, the amount of solids in the organic vehicle being 8 to 12 parts by weight based on 100 parts by weight of the photosensitive paste composition and 10 to 20 parts by weight based on 100 parts by weight of the conductive particle;
drying the photosensitive paste film;
exposing the formed paste coating to a light source to form a pattern;
developing the pattern; and
burning the pattern.

20. The plasma display panel electrode of claim 19, wherein the conductive particle has a specific surface area of 0.3 to 2 m²/g and an average particle diameter of 0.1 to 5 μm;
the inorganic binder has a softening temperature of 400 to 600° C. and an average particle diameter of 5 μm or less, and an amount of the inorganic binder is 0.1 to 10 parts by weight with respect to 100 parts by weight of the conductive particle; and
an amount of the organic vehicle is 20 to 100 parts by weight with respect to 100 parts by weight of the conductive particle.
